(19) United States
(12) Patent Application Publication
(10) Pub. No.: US 2026/0276470 A1
(43) Pub. Date: Sep. 17, 2026

(54) PERSONAL PROTECTIVE EQUIPMENT TESTING SYSTEM AND METHOD

(71) Applicant: ANSELL LIMITED, Richmond, Victoria (AU)

(72) Inventors: Ashleigh Lauren DAVIDSON, Hull (GB); Hazem MATAR, Basingstoke (GB); Luke Daniel SAVORY, Hull (GB); Robert Peter CHILCOTT, Andover (GB); Michael Paul DRAPER, York (GB); Caspar David HOYER, Winchester (GB); Rustam ARYOOBI, Aldershot (GB)

(21) Appl. No.: 19/480,208

(22) PCT Filed: May 22, 2024
(86) PCT No.: PCT/AU2024/050525

§ 371 Date: Oct. 30, 2025

Related U.S. Application Data
(60) Provisional application No. 63/468,234, filed on May 22, 2023.

(51) Int. Cl. G01M 3/04

(52) U.S. Cl. CPC G01M 3/04

(57) ABSTRACT

A personal protective equipment testing system is disclosed which includes a control enclosure and a testing enclosure in which a mannequin configured to allow one or more pieces of personal protective equipment to be disposed thereon or thereover includes a plurality of sensors in electrical communication with a system controller, and a delivery system to direct testing materials into contacts with the piece of personal protective equipment. A method of testing a piece of personal protective equipment is also disclosed.

### FIELD

The present disclosure is directed to a personal protective equipment testing system and method. In particular, a chemical challenge test system for personal protective equipment (PPE) using an exposure sensing animated mannequin and a corresponding monitoring system and methods utilizing the same.

### BACKGROUND

Current testing strategies for the evaluation of personal protective equipment (PPE) ensembles generally adhere to standardized testing regimes. Typically, the testing regimes include evaluation of swatches of material, prepared according to standardized mounting and testing procedures, which are then exposed to a battery of various contaminants and monitored to determine breakthrough times using suitable analytical equipment, typically diffusion cells. In a similar vein, seals, seams and other closure methods are also evaluated using such diffusion cells and other testing regimes across a battery of chemicals and other contaminants.

Currently utilized forms for the evaluation of personal protective equipment testing are generally regarded as an effective method for selecting appropriate materials and determining material compatibility. However, the inventors have observed that full size evaluation of PPE garments, e.g., suits, coveralls, and the like, made from these materials, not to mention combinations of different PPE items and the resulting interfaces, are seldom tested against chemical contaminants from which they are intended to protect.

The reason for this disjunct is that in order to test a garment, the garment must be donned and then manipulated while being exposed to a chemical, while simultaneously providing a means to determine both if and an amount of breakthrough that has occurred during this testing.

Such testing is currently conducted utilizing a man in simulant test (MIST), typically according to ASTM F2588-12 or an equivalent thereof. MIST testing includes equipping a human with absorbent materials, e.g., dosimeters, at 36 locations on his body, having the human don the garment and undertake a series of movements while being exposed to a material which is intended to simulate the material of interest, followed by analyzing the dosimeters to determine if and where breakthrough has occurred.

Simulants are employed in the evaluation of these ensembles whilst performing MIST testing which are not harmful to the human participating in the testing. MIST testing can provide a level of certainty as to the protective efficacy of a particular suit or garment, such testing is also able to determine the amount of contaminant found at each of the 36 anatomical locations using passive absorbent dosimeters. However, the inventors have observed that major disadvantages of MIST testing include the inability to determine real time measurements. Further, MIST testing is, at best, an approximation and fails to allow determinations using the actual material of interest, which may have physical properties which vary widely from the simulant used. Standard EN “Type” testing for chemical protective clothing is even more lacking, making use only of surface tension controlled water with a blue dye for clothing affording liquid protection, and an inflation test with tolerance on pressure drop to test for the PPE being gastight.

The inventors have further observed that MIST testing protocols are currently conducted within a chamber filled with simulant vapor, and thus fail to allow for determination of efficacy of a particular garment under alternative exposure conditions which may impact the efficacy of the suit, especially within industrial applications and subsequent potential exposures such as spray, jet, or spill exposures, which are common forms of exposure in real-world situations.

Attempts to rectify these shortcomings include the Several relevant technologies existing for the use and design of animated robotic mannequins for the testing of chemical protective clothing. Examples include the Defense Science and Technology Laboratory (Dstl), and their “Porton Man” project, a Canadian mannequin developed for the Defense Research and Development Canada, and the Protection Ensemble Test Mannequin (PETMAN) developed for the US Army.

These systems involve a mannequin mounted on a support structure, that can perform similar movements in combination with various data acquisition systems which provide time-stamped information based on a particular movement of the mannequin. These systems are configured to test and evaluate protective equipment against chemical warfare agents, all of which have similar properties. However, similar to MIST testing, the equipment is configured, and the various testing protocols are designed around exposure methods employed in the use of chemical warfare agents which are typically in vapor state. Another common attribute of such testing apparatus is a level of complexity and expense, restricting both availability and access of such a testing system, relegating such systems and testing outside of the regulatory requirements required of more common PPE.

### SUMMARY

In embodiments described herein, a personal protective equipment testing system comprises a control enclosure in electrical communication with a testing enclosure, wherein the testing enclosure is configurable to prevent fluid communication with the control enclosure and to prevent fluid communication with an external environment; a mannequin disposed within the testing enclosure, wherein the mannequin has an outer surface having a shape approximating an adult human being, wherein the mannequin is configured to allow one or more pieces of personal protective equipment to be disposed over at least a portion of the outer surface; the testing enclosure further comprising a plurality of sensors, each in electrical communication with a system controller, wherein at least one of the plurality of sensors is disposed on or located at or within the outer surface of the mannequin; a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; and wherein the system controller is configured to provide electronic communication between the control enclosure and the delivery system to manipulate an environment within the testing enclosure simultaneous with providing electronic communication between the control enclosure and the plurality of sensors.

In embodiments, a method of testing a piece of personal protective equipment comprises i) disposing the piece of personal protective equipment over a mannequin of a personal protective equipment testing system; ii) directing one or more testing materials into a testing enclosure such that at least a portion of the one or more testing materials contacts the piece of personal protective equipment; and iii) obtaining an output from one or more of a plurality of sensors disposed within the testing enclosure; wherein the personal protective equipment testing system comprises: a control enclosure in electrical communication with the testing enclosure, wherein the testing enclosure is configurable to prevent fluid communication with the control enclosure and to prevent fluid communication with an external environment; the mannequin is disposed within the testing enclosure, wherein the mannequin has an outer surface having a shape approximating an adult human being, wherein the mannequin is configured to allow one or more pieces of personal protective equipment to be disposed over at least a portion of the outer surface; the testing enclosure further comprising the plurality of sensors, each in electrical communication with a system controller, wherein at least one of the plurality of sensors is disposed on or located at or within the outer surface of the mannequin; a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; wherein the system controller is configured to provide electronic communication between the control enclosure and the delivery system to manipulate an environment within the testing enclosure simultaneous with providing electronic communication between the control enclosure and the plurality of sensors.

### BRIEF DESCRIPTION OF THE DRAWINGS

FIG. 1 depicts a testing mannequin according to embodiments of the present disclosure.

FIG. 2 depicts a rear view of the testing mannequin shown in FIG. 1 according to embodiments of the present disclosure.

FIG. 3 depicts a side view of the testing mannequin shown in FIG. 1 according to embodiments of the present disclosure.

FIG. 4 depicts a side view of the testing mannequin shown in FIG. 1 positioned in a squatting position according to embodiments of the present disclosure.

FIG. 5 is block diagram depicting an artificial respiratory system of a mannequin according to embodiments of the present disclosure.

FIG. 6 is a block diagram of a personal protective equipment testing system according to embodiments of the present disclosure.

FIG. 7 is a perspective view of a personal protective equipment testing system according to embodiments of the present disclosure.

FIG. 8 is a flow chart depicting a method of testing a piece of personal protective equipment according to embodiments of the present disclosure.

### DETAILED DESCRIPTION

The present disclosure is directed to an apparatus, system, and methods which include a life-size animated mannequin configured for specific movement types which may emulate to some extent MIST and other protocols, which is further configured to include integrated real-time chemical sensors to measure the protective efficacy of PPE against an actual chemical or contaminant of interest, or mixture thereof, under a plurality of exposure conditions.

In embodiments, the system includes an exposure or testing enclosure having an articulated mannequin disposed therein, along with the corresponding sensing equipment and a controller to control the various exposure and testing schemes, as well as acquire, monitor, analyze and log or store data from the various analyzers. Methods include utilizing the system or systems for validation of sample collection matrices having determined limits of detection and quantification. In embodiments, in addition to various electronic sensors suitable for detection and/or quantification of various target contaminants. Embodiments may also include various dosimeters, which in embodiments are in the form of activated carbon pads or other absorbents and/or adsorbents, suitable for determining a total exposure of one or more contaminants during testing which may be correlated with the real time sensors to produce a fully integrated understanding of the ability of a particular PPE to provide protection in a particular environment, or in a plurality of environments and levels of exposure.

Methods according to embodiments disclosed herein further include analytical methods of quantification for each chemical contaminant configured to allow for the determination of particular doses and limits of exposure.

Furthermore, in embodiments, methods include establishing a baseline and control using an unprotected mannequin, for each exposure scenario e.g., spray, jet, spill/splash or gas/vapor exposures, which are impossible to obtain according to current MIST testing protocols.

In embodiments, a personal protective equipment testing system, comprises a control enclosure in electrical communication with a testing enclosure, wherein the testing enclosure is configurable to prevent fluid communication with the control enclosure and to prevent fluid communication with an external environment; a mannequin disposed within the testing enclosure, wherein the mannequin has an outer surface having a shape approximating an adult human being, wherein the mannequin is configured to allow one or more pieces of personal protective equipment to be disposed over at least a portion of the outer surface; the testing enclosure further comprising a plurality of sensors, each in electrical communication with a system controller, wherein at least one of the plurality of sensors is disposed on or located at or within the outer surface of the mannequin; a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; and wherein the system controller is configured to provide electronic communication between the control enclosure and the delivery system to manipulate an environment within the testing enclosure simultaneous with providing electronic communication between the control enclosure and the plurality of sensors.

In embodiments, the delivery system is configured such that at least one of the testing materials is a material the piece of personal protective equipment is designed to provide protection against. For example, a piece of PPE designed to provide protection against aromatic organic solvents such as benzene could be tested with benzene instead of colored water according to current testing methods in the art. In embodiments, the delivery system is configured to direct a liquid testing material into the testing enclosure directly into contact with a portion of a piece of personal protective equipment disposed over at least a portion of the outer surface of the mannequin in an amount, at a flow rate, and over a period of time sufficient to simulate a splash test, wherein the amount of the test material is being thrown onto the portion of piece of personal protective equipment. Such testing is typically referred to as a splash test, e.g., having a bucket of the material thrown on the subject. In embodiments, at least one of the plurality of sensors is suitable to determine an amount of an external force applied by the amount of the test material to the portion of the outer surface of the mannequin located directly beneath the portion of the piece of personal protective equipment.

In embodiments, the personal protective equipment testing system further comprises one or more sensors located within the control enclosure in electronic communication with the controller.

In embodiments, the personal protective equipment testing system further comprises a sealable opening disposed between the control enclosure and the testing enclosure configured to allow human egress in and out of the testing enclosure.

In embodiments, the mannequin comprises articulatable appendages configured such that the mannequin may be positioned in a squatting position. In embodiments, the mannequin comprises articulatable appendages configured such that the mannequin may be positioned with one arm and/or one leg raised relative to the other corresponding appendage. In embodiments, one or more of the articulatable appendages comprises an actuator in electrical communication with and controllable by the controller, configured such that the mannequin may be changed from a first position to a second position over a period of time essentially equal to a period of time required for a corresponding movement of a human being, simultaneous with the delivery system directing one or more testing materials into contact with a piece of personal protective equipment disposed over at least a portion of the outer surface of the mannequin.

In embodiments, the mannequin is configured to turn its head simultaneous with the delivery system directing one or more testing materials into contact with a piece of personal protective equipment disposed over at least a portion of the outer surface of the mannequin.

In embodiments, the mannequin is configured to twist about a torso simultaneous with the delivery system directing one or more testing materials into contact with a piece of personal protective equipment disposed over at least a portion of the outer surface of the mannequin.

In embodiments, the mannequin is configured to perform walking motions simultaneous with the delivery system directing one or more testing materials into contact with a piece of personal protective equipment disposed over at least a portion of the outer surface of the mannequin.

In embodiments, the mannequin further comprises a simulated respiratory tract in fluid communication with a mouth of the mannequin, in electronic communication with the controller, and configured to simulate human breathing simultaneous with the delivery system directing one or more testing materials into contact with a piece of personal protective equipment disposed over at least a portion of the outer surface of the mannequin.

In embodiments, the mannequin is configured for wearing of a respirator, safety goggles and/or eye protection simultaneous with the delivery system directing one or more testing materials into contact with a piece of personal protective equipment disposed over at least a portion of the outer surface of the mannequin.

In embodiments, an inner portion of mannequin is encased within the outer surface of the mannequin, and wherein the outer surface of the mannequin is resistant to corrosive chemical environments under elevated temperatures.

In embodiments, one or more of the plurality of sensors comprises a video camera.

In embodiments, the plurality of sensors comprise one or more of an ion-selective field effect transistor, an electrochemical sensor, a potentiometric sensor, a chemically modified electrode sensor, a metal oxide sensor, a photoionization detector, a thermocouple, a humidity sensor, an accelerometer, a mass spectrometer, an infrared spectrometer, an x-ray diffraction spectrometer, or a UV-Vis spectrometer.

In embodiments, the controller is configured to monitor, display, process and store data from the plurality of sensors.

In embodiments, one or more of the plurality of sensors is in wireless electronic communication with the controller.

In embodiments, the system includes an articulated mannequin for PPE ensemble testing. In embodiments, an outer surface of the mannequin is configured to include materials which do not readily absorb or react with a range of potential contaminants. In embodiments, the mannequin is configured to be fixed into several positions such as squatting, or arms raised in static positions. In an embodiment, the mannequin is configured to have proportions corresponding to anatomical proportions akin to a 70 kg man. In embodiments, certain portions of the mannequin are detachable to enable donning and doffing of protective ensembles.

In embodiments, the mannequin is configured to include a range of chemical collection matrices located on discreet locations which include electronic chemical sensors, or both dosimeters and sensors will mimic currently regulated placement of dosimeters for testing of protective ensembles. The mannequin may also include one or more entry points which can be fully sealed to allow for electronic communication between sensors and corresponding electronic evaluation equipment, which provide power to the various systems of the mannequin, and in embodiments, which provide both makeup gases for sensors, and which exhaust materials produced by sensors which would otherwise not be present in a real-world environment.

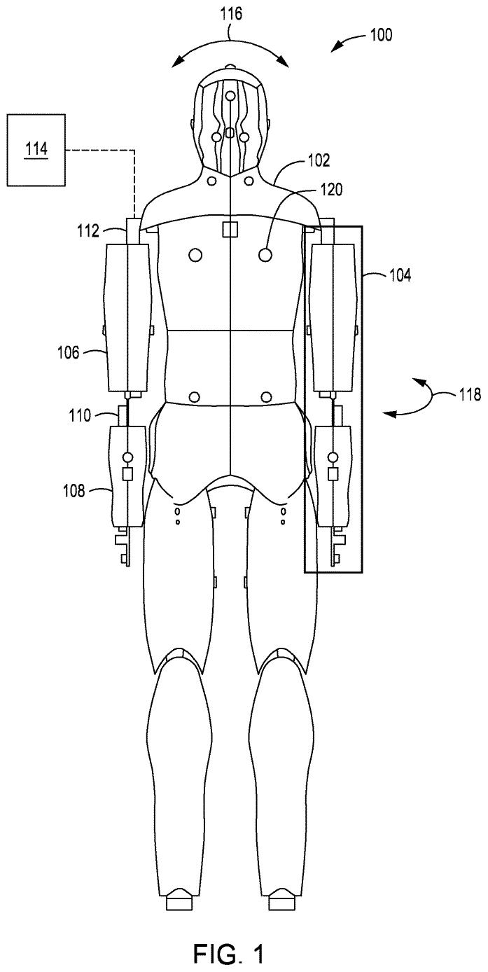

FIG. 1 depicts an articulated mannequin 100 according to embodiments disclosed herein. The mannequin has an outer surface 102 having a shape approximating an adult human being, which in embodiments is anatomical proportions akin to a 70 kg man. In embodiments, the mannequin 100 is configured to allow one or more pieces of personal protective equipment 104 to be disposed over at least a portion of the outer surface 102.

As shown in FIG. 1, in embodiments, the mannequin comprises articulatable appendages e.g., appendage portion 106 engaged with appendage portion 108 via an adjustable joint or connector 110. In embodiments, the mannequin comprises articulatable appendages configured such that the mannequin may be positioned with one arm and/or one leg raised relative to the other corresponding appendage (not shown).

As further shown in FIG. 1, in embodiments, the or more of the articulatable appendages comprises an actuator 112, e.g., an electric or pneumatic device for moving the appendage, in electrical communication with, and controllable by a system controller 114, configured such that the mannequin 100 may be changed from a first position, e.g., standing as shown in FIG. 1, to a second position e.g., squatting as shown in FIG. 4, over a period of time essentially equal to a period of time required for a corresponding movement of a human being. For example, if an average time required for a human being to change from standing to squatting is about 3 seconds, the mannequin is configured such that the mannequin 100 may be changed from a standing position as shown in FIG. 1, to the squatting position as shown in FIG. 4, over a period of time of about 3 seconds. In this way, the testing system is able to provide real-world testing of PPE under simulated real-world conditions utilizing actual hazardous materials the PPE is designed to protect against. In embodiments, the movement of the mannequin by the actuator is conducted simultaneously with the mannequin being exposed or contacted with a testing material, i.e., simultaneous with the delivery system directing one or more testing materials into contact with a piece of personal protective equipment 104 disposed over at least a portion of the outer surface 102 of the mannequin 100.

In embodiments, at least one of the plurality of sensors 120 is disposed on or located at or within the outer surface 102 of the mannequin 100.

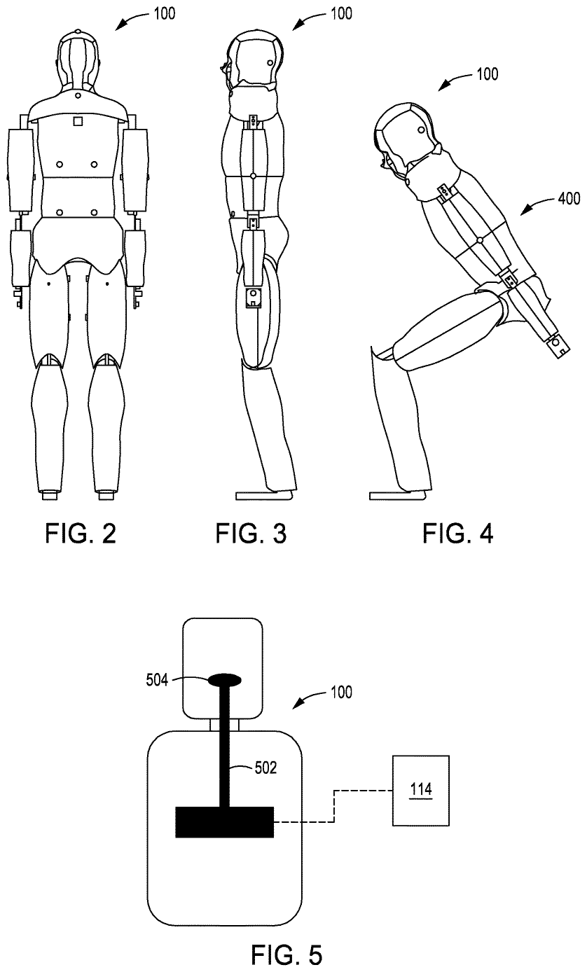

FIG. 2 depicts a rear view of the articulated mannequin 100. FIG. 3 depicts a side view of the articulated mannequin 100. FIG. 4 depicts a side view of the articulated mannequin 100 in a squatting position 400.

In embodiments, the mannequin is configured to turn its head 116, to twist about a torso 118, and/or conduct walking motions (not shown) simultaneous with the delivery system directing one or more testing materials into contact with a piece of personal protective equipment disposed over at least a portion of the outer surface of the mannequin. In embodiments, the mannequin is configured to ensure no external support structures impact the integrity of any PPE, to thereby provide greater resolution of the impact of real time movements on contaminant ingress and movement within the PPE.

In embodiments, the outer surface of the mannequin is constructed of materials which does not readily absorb and/or off-gas materials being tested, or which would interfere with a particular chemical sensor being employed.

In embodiments, the outer surface or “skin” of the mannequin is formed from thermoset resin, a thermoplastic resin, such as polyamide resins, and/or a flexible plastic and/or elastomeric material. In some embodiments, the outer surface of the mannequin is coated with a material suitable for a particular testing regime, which may differ from test to test.

As shown by block diagram in FIG. 5, in embodiments, the mannequin 100 further comprises a simulated respiratory tract 502 in fluid communication with a mouth 504 of the mannequin 100, in electronic communication with the controller, and configured to simulate human breathing simultaneous with the delivery system directing one or more testing materials into contact with a piece of personal protective equipment disposed over at least a portion of the outer surface of the mannequin.

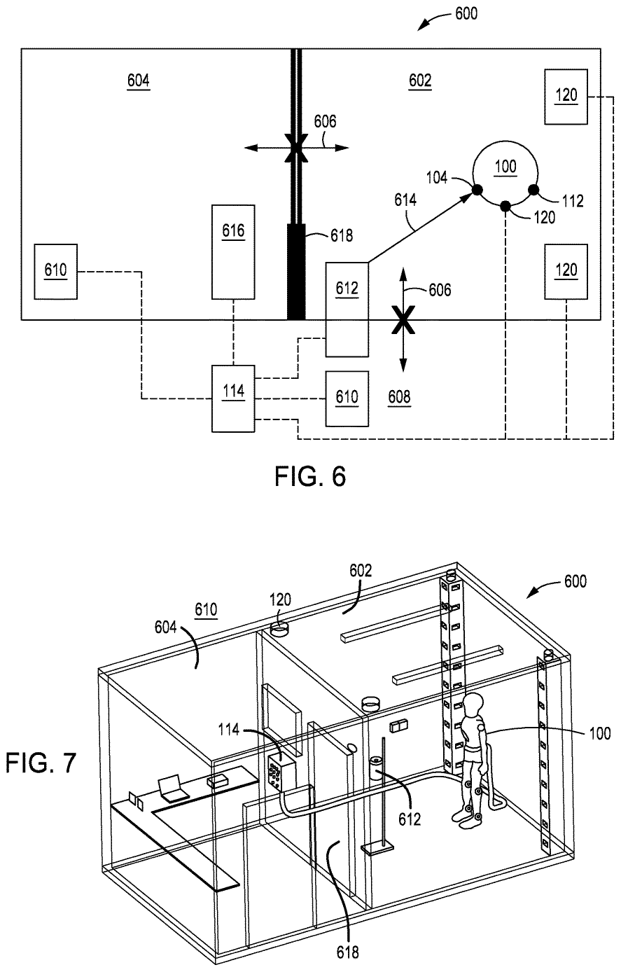

As shown in FIG. 6, in embodiments, the personal protective equipment testing system 600, which for brevity is also referred to herein simply as the “testing system”, includes a control enclosure 604 in electrical communication with a testing enclosure 602, wherein the testing enclosure is configurable to prevent fluid communication 606 with the control enclosure 604 and to prevent fluid communication with an external environment 608. In embodiments, the testing enclosure 602 further comprising a plurality of sensors 610, each in electrical communication with a system controller, wherein at least one of the plurality of sensors is disposed on or located at or within the outer surface of the mannequin 100 as shown herein.

The testing system 600 further includes a delivery system 612, which may include portions located internal to the testing enclosure 602, or may have portions external to the testing enclosure, but which is in fluid communication with the testing enclosure 602 in electronic communication with the system controller 114. The delivery system 612 configured to direct one or more testing materials 614 into the testing enclosure 602 such that at least a portion of the one or more testing materials 614 contacts a piece of personal protective equipment 104 disposed over at least a portion of the outer surface of the mannequin 100. The system controller 114 is configured to provide electronic communication between the control enclosure 604, e.g., via a control panel 616, and the delivery system 612 to manipulate an environment within the testing enclosure 602 simultaneous with providing electronic communication between the control enclosure 604 and the plurality of sensors 120, which in embodiments further includes one or more sensors 610 disposed within the control enclosure 604, and/or disposed in the external environment 608 to ensure the safety of operators within the control enclosure and elsewhere. As shown in FIG. 6, in embodiments, the testing system further comprises a sealable opening 618 disposed between the control enclosure 604 and the testing enclosure 602 configured to allow human egress in and out of the testing enclosure 602, e.g., from the control enclosure 604.

A perspective view of an embodiment of a testing system 600 is shown in FIG. 7.

In embodiments, the system includes one or more jet, splash, aerosol and/or spray systems which are calibrated to ensure dose repeatability from a remote actuator. In embodiments, the spray, aerosol, splash, and/or jet patterns are configured to produce a particular pattern at a set distance from the mannequin to allow measurement of exposure on, and withing a PPE garment disposed over the mannequin.

In embodiments, a splash test utilizes a splash system configured to deliver a particular volume of material into contact with the testing apparatus over a relatively small area in a short period of time, wherein the liquid impacts the test mannequin with a force consistent with such an event. Such testing is commonly absent in the art. A splash test being designed to replicate having a volume of a material forcibly directed into contact with the mannequin over a small area, similar to the real world experience of having a “bucket” of liquid thrown in one's face or on one's clothing. Accordingly, in embodiments, the mannequin includes a load cell or other device suitable to determine an external force applied to an external surface of the mannequin.

In embodiments, the jet, splash, aerosol, and/or spray systems may include various dyes and/or fluorescent materials subject to photographic analysis and quantification.

In embodiments, the mannequin has human-like features and the dimensions of an average person. This includes a torso with 2 arms and legs attached with two hands and two feet, respectively and a head presenting a face. In embodiments, the mannequin's hands fit in normally sized gloves, e.g., glove size 9, which in embodiments, the mannequin's hand may include un-articulated hand with abducted fingers, and in other embodiments, the mannequin's hand includes an at least partially articulated hand and/or fingers.

In embodiments, the mannequin has feet that fit in boots of a normally sized boot or shoe, e.g., UK size 8-9.

In embodiments, the mannequin can be donned with a one-piece, fully encapsuled chemical protective suit including boots. This can be achieved either by making various parts or assemblies removable, free moving or with the use of an additional supporting structure for stability while donning and doffing.

In embodiments, the mannequin includes one or more inner compartments, e.g., within a chest cavity, which contains an IP65 rated, or above, accessible enclosure dimensioned and arranged to house any electronic devices required within the mannequin.

In embodiments, at least a portion of the electronic chemical sensors are in wireless electronic communication with one or more electronic data systems. In embodiments, all of the electronic chemical sensors are in wireless electronic communication with one or more electronic data systems. In embodiments, all of the necessary cabling required for electronic data communication is routed through a single port, which is likewise sealable to prevent ingress during testing.

In embodiments, the mannequin is animated and can perform one or more moves from a standing position, including a squat to ~90 degrees between the two segments of the leg between the femur and tibia, and then return to the standing position; raise the arms about 180 degrees to a vertical position and lower the arms.

In embodiments, the mannequin is configured to be programmed in order to alter movements and/or pause during motions without adversely affecting the stability. In embodiments, the mannequin is configured to perform two or more movements simultaneously.

In embodiments, the mannequin is free-standing and does not require any external support during performing the movements. In some embodiments, the mannequin is free standing and includes one or more external supports to prevent any external cables from interfering with movement or testing.

In embodiments, the recovery time between a first movement and a second movement is less than about 10 seconds, or less than about 5 seconds, or less than about 3 seconds.

In embodiments, the mannequin is configured to turn its head and perform walking motions. In embodiments, the mannequin is configured to lift one leg at a time, which in some embodiments includes the use of an external support.

In embodiments, the mannequin is configured to “twist its torso”. In embodiments, the mannequin is configured to move hands and/or fingers.

In embodiments, any portion of the mannequin exposed to a testing substance is formed from organic vapor resistant materials. In embodiments, the mannequin is encased within a vacuum or otherwise sealed “skin” suitable for use in both corrosive chemical environments, under elevated temperatures, and/or the like.

In embodiments, all electronic components of the mannequin are secured within enclosures to prevent contact with a chemical vapor atmosphere during testing.

In embodiments, the mannequin is configured for use with a Robot Open Source (ROS) control system. In embodiments, the mannequin is connected wirelessly to an ROS control system. In embodiments, the mannequin is connected directly via cables to an ROS control system, which may include one or more communication protocols including Modbus RTU protocols. In embodiments, the mannequin is connected via one or more main ‘backbone’ cables with spurs for one or more electrochemical sensor. In embodiments, the mannequin further includes one or more internal data logging systems configured to log data produced by various sensors in unison with positions of various indicators which correlate to a particular position of the mannequin.

In embodiments, the mannequin is powered by one or more internal rechargeable batteries. In embodiments, the mannequin is controlled wirelessly via wifi and/or Bluetooth or a similar near field radio serial communication protocol. In embodiments, the one or more chemical sensors are configured to transmit and log data wirelessly using Bluetooth or a similar technology.

In embodiments, the mannequin requires a maximum of 3 seconds to change from a first position to another position, and another 3 seconds to return to the first position, as required by subjects during human testing.

In embodiments, the length of time required for a motion is adjustable, e.g., it can be made to move slower than the required 3 seconds.

In embodiments, the mannequin is configured to be controlled remotely from another room with a rudimentary controller, which may include a keyboard. In embodiments, the mannequin includes chemical detectors configured to be read in real time from an interface along with the data being logged.

In embodiments, the mannequin comprises a plurality of locations configured to accept electrochemical detectors. In embodiments, the mannequin comprises at least 36 locations configured to accept electrochemical detectors and/or inlets to one or more electrochemical detectors.

In embodiments, the mannequin includes recesses which allow the sensors to be placed within the structure, configured to allow the sensing portion of the electrochemical structure to be appropriately positioned and arranged, while protecting other portions of the detector.

In embodiments, the mannequin further includes a plurality of locations suitable for attachment of dosimeter or absorbent pads which may be removed and subject to chemical analysis after testing.

In embodiments, the mannequin includes a tube simulating a respiratory tract which connects the mouth with a detector to allow the simulation of breathing. In embodiments, the mannequin includes a plurality of temperature and/or humidity sensors. In embodiments, the mannequin is configured for testing of a gas tight, fully sealed suit, a multi-layer light protective suit with a hood and elasticated cuffs for hands and feet, and/or a breathable laminate suit for low-concentration chemicals, either alone or in combination with other PPE items as desired, thereby effectively emulating end user risk assessment for a particular task.

In embodiments, the mannequin is configured to allow for wearing of a respirator, safety goggles and/or eye protection, or a combination thereof.

In embodiments, the mannequin is equipped with a plurality of electrochemical detectors, which in embodiments may include potentiometric detectors, amperometric detectors, and/or conductometric detectors.

In embodiments, the electrochemical detector includes an ion-selective electrodes, a coated wire electrode, and/or a field effect transistor sensing configuration, which may be membrane-based devices comprising permselective ion-conducting materials and determine a potential relative to a reference electrode. In embodiments, the mannequin includes one or more inlets and outlets isolated from the testing atmosphere which provide a suitable reference material to allow operation of an electrochemical sensor.

In embodiments, the electrochemical sensors include an ion-selective field effect transistors (ISFET) comprising an ion-sensing membrane directly on a gate area of a field effect transistor which in embodiments, is configured for sensing several material simultaneously.

In embodiments, the electrochemical sensors include metal oxide sensors. In embodiments, the electrochemical sensors include a chemically modified electrodes (CME) sensor comprising an immobilized agent disposed on an electrode surface though chemical reactions, chemisorption, composite formation or polymer coating. In embodiments, the mannequin includes one or more photoionization detectors (PID), suitable for, and calibrated to detect and quantify one or more particular contaminants.

In embodiments, the sensors utilize an I2C interface, a CAN bus interface, a serial interface, or any combination thereof.

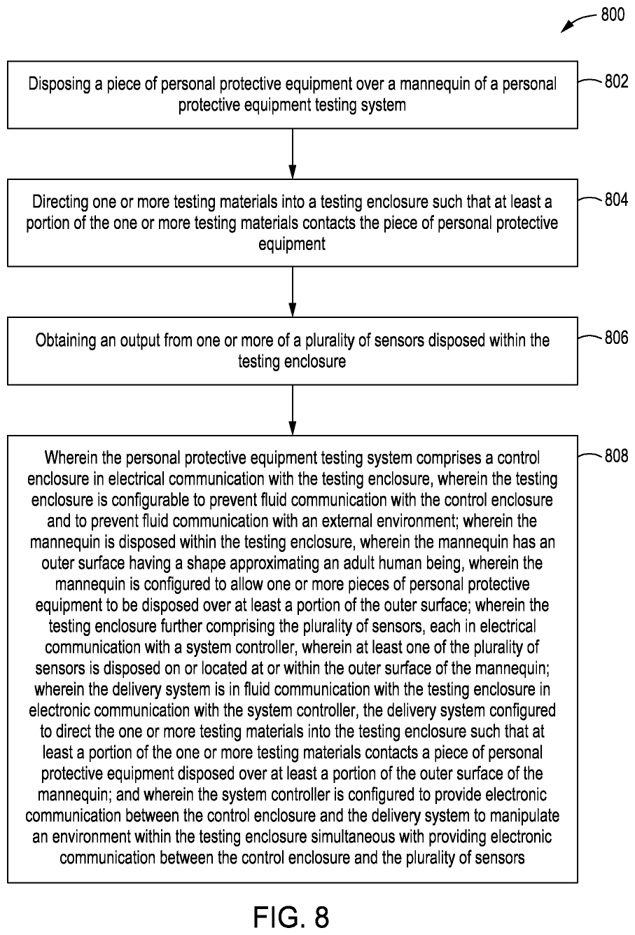

FIG. 8 depicts a method 800 of testing a piece of personal protective equipment, comprising disposing the piece of personal protective equipment over a mannequin of a personal protective equipment testing system (block 802); directing one or more testing materials into a testing enclosure such that at least a portion of the one or more testing materials contacts the piece of personal protective equipment (block 804); and obtaining an output from one or more of a plurality of sensors disposed within the testing enclosure (block 806), wherein the personal protective equipment testing system comprises: a control enclosure in electrical communication with the testing enclosure, wherein the testing enclosure is configurable to prevent fluid communication with the control enclosure and to prevent fluid communication with an external environment; the mannequin is disposed within the testing enclosure, wherein the mannequin has an outer surface having a shape approximating an adult human being, wherein the mannequin is configured to allow one or more pieces of personal protective equipment to be disposed over at least a portion of the outer surface; the testing enclosure further comprising the plurality of sensors, each in electrical communication with a system controller, wherein at least one of the plurality of sensors is disposed on or located at or within the outer surface of the mannequin; a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; wherein the system controller is configured to provide electronic communication between the control enclosure and the delivery system to manipulate an environment within the testing enclosure simultaneous with providing electronic communication between the control enclosure and the plurality of sensors (block 808).

Embodiments of the instant disclosure include:
E01. A personal protective equipment testing system, comprising:
   a control enclosure in electrical communication with a testing enclosure, wherein the testing enclosure is configurable to prevent fluid communication with the control enclosure and to prevent fluid communication with an external environment;
   a mannequin disposed within the testing enclosure, wherein the mannequin has an outer surface having a shape approximating an adult human being, wherein the mannequin is configured to allow one or more pieces of personal protective equipment to be disposed over at least a portion of the outer surface;
   the testing enclosure further comprising a plurality of sensors, each in electrical communication with a system controller, wherein at least one of the plurality of sensors is disposed on or located at or within the outer surface of the mannequin;
   a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; and
   wherein the system controller is configured to provide electronic communication between the control enclosure and the delivery system to manipulate an environment within the testing enclosure simultaneous with providing electronic communication between the control enclosure and the plurality of sensors.
E02. The personal protective equipment testing system according to embodiment E1, wherein the delivery system is configured such that at least one of the testing materials is a material the piece of personal protective equipment is designed to provide protection against.
E03. The personal protective equipment testing system according to embodiments E1-E2, wherein the delivery system is configured to direct a liquid testing material into the testing enclosure directly into contact with a portion of a piece of personal protective equipment disposed over at least a portion of the outer surface of the mannequin in an amount, at a flow rate, and over a period of time sufficient to simulate a splash test, wherein the amount of the test material is being thrown onto the portion of piece of personal protective equipment.
E04. The personal protective equipment testing system according to embodiments E1-E3, wherein at least one of the plurality of sensors is suitable to determine an amount of an external force applied by the amount of the test material to the portion of the outer surface of the mannequin located directly beneath the portion of the piece of personal protective equipment.
E05. The personal protective equipment testing system according to embodiments E1-E4, further comprising one or more sensors located within the control enclosure in electronic communication with the controller.
E06. The personal protective equipment testing system according to embodiments E1-E5, further comprising an sealable opening disposed between the control enclosure and the testing enclosure configured to allow human egress in and out of the testing enclosure.
E07. The personal protective equipment testing system according to embodiments E1-E6, wherein the mannequin comprises articulatable appendages configured such that the mannequin may be positioned in a squatting position.
E08. The personal protective equipment testing system according to embodiments E1-E7, wherein the mannequin comprises articulatable appendages configured such that the mannequin may be positioned with one arm and/or one leg raised relative to the other corresponding appendage.
E09. The personal protective equipment testing system according to embodiments E1-E8 wherein one or more of the articulatable appendages comprises an actuator in electrical communication with and controllable by the controller, configured such that the mannequin may be changed from a first position to a second position over a period of time essentially equal to a period of time required for a corresponding movement of a human being, simultaneous with the delivery system directing one or more testing materials into contact with a piece of personal protective equipment disposed over at least a portion of the outer surface of the mannequin.
E10. The personal protective equipment testing system according to embodiments E1-E9, wherein the mannequin is configured to turn its head simultaneous with the delivery system directing one or more testing materials into contact with a piece of personal protective equipment disposed over at least a portion of the outer surface of the mannequin.
E11. The personal protective equipment testing system according to embodiments E1-E10, wherein the mannequin is configured to twist about a torso simultaneous with the delivery system directing one or more testing materials into contact with a piece of personal protective equipment disposed over at least a portion of the outer surface of the mannequin.
E12. The personal protective equipment testing system according to embodiments E1-E11, wherein the mannequin is configured to perform walking motions simultaneous with the delivery system directing one or more testing materials into contact with a piece of personal protective equipment disposed over at least a portion of the outer surface of the mannequin.
E13. The personal protective equipment testing system according to embodiments E1-E12, wherein the mannequin further comprises a simulated respiratory tract in fluid communication with a mouth of the mannequin, in electronic communication with the controller, and configured to simulate human breathing simultaneous with the delivery system directing one or more testing materials into contact with a piece of personal protective equipment disposed over at least a portion of the outer surface of the mannequin.
E14. The personal protective equipment testing system according to embodiments E1-E13, wherein the mannequin is configured for wearing of a respirator, safety goggles and/or eye protection simultaneous with the delivery system directing one or more testing materials into contact with a piece of personal protective equipment disposed over at least a portion of the outer surface of the mannequin.
E15. The personal protective equipment testing system according to embodiments E1-E14, wherein an inner portion of mannequin is encased within the outer surface of the mannequin, and wherein the outer surface of the mannequin is resistant to corrosive chemical environments under elevated temperatures.
E16. The personal protective equipment testing system according to embodiments E1-E15, wherein one or more of the plurality of sensors comprises a video camera.
E17. The personal protective equipment testing system according to embodiments E1-E16, wherein the plurality of sensors comprise one or more of an ion-selective field effect transistor, an electrochemical sensor, a potentiometric sensor, a chemically modified electrode sensor, a metal oxide sensor, a photoionization detector, a thermocouple, a humidity sensor, an accelerometer, a mass spectrometer, an infrared spectrometer, an x-ray diffraction spectrometer, or a UV-Vis spectrometer.
E18. The personal protective equipment testing system according to embodiments E1-E17, wherein the controller is configured to monitor, display, process and store data from the plurality of sensors.
E19. The personal protective equipment testing system according to embodiments E1-E18, wherein one or more of the plurality of sensors is in wireless electronic communication with the controller.
E20. A method of testing a piece of personal protective equipment, comprising:
   i) disposing the piece of personal protective equipment over a mannequin of a personal protective equipment testing system according to embodiments E1-E19;
   ii) directing one or more testing materials into a testing enclosure such that at least a portion of the one or more testing materials contacts the piece of personal protective equipment; and
   iii) obtaining an output from one or more of a plurality of sensors disposed within the testing enclosure.
E21. A method of testing a piece of personal protective equipment, comprising:
   i) disposing the piece of personal protective equipment over a mannequin of a personal protective equipment testing system;
   ii) directing one or more testing materials into a testing enclosure such that at least a portion of the one or more testing materials contacts the piece of personal protective equipment; and
   iii) obtaining an output from one or more of a plurality of sensors disposed within the testing enclosure;
   wherein the personal protective equipment testing system comprises:
   a control enclosure in electrical communication with the testing enclosure, wherein the testing enclosure is configurable to prevent fluid communication with the control enclosure and to prevent fluid communication with an external environment;
   the mannequin is disposed within the testing enclosure, wherein the mannequin has an outer surface having a shape approximating an adult human being, wherein the mannequin is configured to allow one or more pieces of personal protective equipment to be disposed over at least a portion of the outer surface;
   the testing enclosure further comprising the plurality of sensors, each in electrical communication with a system controller, wherein at least one of the plurality of sensors is disposed on or located at or within the outer surface of the mannequin;
   a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin;
   wherein the system controller is configured to provide electronic communication between the control enclosure and the delivery system to manipulate an environment within the testing enclosure simultaneous with providing electronic communication between the control enclosure and the plurality of sensors.

While this disclosure has been described by reference to certain specific embodiments and examples, it will be understood that this disclosure is capable of further modifications. This application is, therefore, intended to cover any variations, uses or adaptations of the disclosure following the general principles thereof, and including such departures from the present disclosure as come within known or customary practice in the art to which this disclosure pertains and fall within the limits of the appended claims.

1. A personal protective equipment testing system, comprising:
a control enclosure in electrical communication with a testing enclosure, wherein the testing enclosure is configurable to prevent fluid communication with the control enclosure and to prevent fluid communication with an external environment;
a mannequin disposed within the testing enclosure, wherein the mannequin has an outer surface having a shape approximating an adult human being, wherein the mannequin is configured to allow one or more pieces of personal protective equipment to be disposed over at least a portion of the outer surface;
the testing enclosure further comprising a plurality of sensors, each in electrical communication with a system controller, wherein at least one of the plurality of sensors is disposed on or located at or within the outer surface of the mannequin;
a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin; and
wherein the system controller is configured to provide electronic communication between the control enclosure and the delivery system to manipulate an environment within the testing enclosure simultaneous with providing electronic communication between the control enclosure and the plurality of sensors.

2. The personal protective equipment testing system of claim 1, wherein the delivery system is configured such that at least one of the testing materials is a material the piece of personal protective equipment is designed to provide protection against.

3. The personal protective equipment testing system of claim 1, wherein the delivery system is configured to direct a liquid testing material into the testing enclosure directly into contact with a portion of a piece of personal protective equipment disposed over at least a portion of the outer surface of the mannequin in an amount, at a flow rate, and over a period of time sufficient to simulate a splash test, wherein the amount of the test material is being thrown onto the portion of piece of personal protective equipment.

4. The personal protective equipment testing system of claim 3, wherein at least one of the plurality of sensors is suitable to determine an amount of an external force applied by the amount of the test material to the portion of the outer surface of the mannequin located directly beneath the portion of the piece of personal protective equipment.

5. The personal protective equipment testing system of claim 1, further comprising one or more sensors located within the control enclosure in electronic communication with the controller.

6. The personal protective equipment testing system of claim 1, further comprising an sealable opening disposed between the control enclosure and the testing enclosure configured to allow human egress in and out of the testing enclosure.

7. The personal protective equipment testing system of claim 1, wherein the mannequin comprises articulatable appendages configured such that the mannequin may be positioned in a squatting position.

8. The personal protective equipment testing system of claim 1, wherein the mannequin comprises articulatable appendages configured such that the mannequin may be positioned with one arm and/or one leg raised relative to the other corresponding appendage.

9. The personal protective equipment testing system of claim 8, wherein one or more of the articulatable appendages comprises an actuator in electrical communication with and controllable by the controller, configured such that the mannequin may be changed from a first position to a second position over a period of time essentially equal to a period of time required for a corresponding movement of a human being, simultaneous with the delivery system directing one or more testing materials into contact with a piece of personal protective equipment disposed over at least a portion of the outer surface of the mannequin.

10. The personal protective equipment testing system of claim 9, wherein the mannequin is configured to turn its head simultaneous with the delivery system directing one or more testing materials into contact with a piece of personal protective equipment disposed over at least a portion of the outer surface of the mannequin.

11. The personal protective equipment testing system of claim 9, wherein the mannequin is configured to twist about a torso simultaneous with the delivery system directing one or more testing materials into contact with a piece of personal protective equipment disposed over at least a portion of the outer surface of the mannequin.

12. The personal protective equipment testing system of claim 9, wherein the mannequin is configured to perform walking motions simultaneous with the delivery system directing one or more testing materials into contact with a piece of personal protective equipment disposed over at least a portion of the outer surface of the mannequin.

13. The personal protective equipment testing system of claim 1, wherein the mannequin further comprises a simulated respiratory tract in fluid communication with a mouth of the mannequin, in electronic communication with the controller, and configured to simulate human breathing simultaneous with the delivery system directing one or more testing materials into contact with a piece of personal protective equipment disposed over at least a portion of the outer surface of the mannequin.

14. The personal protective equipment testing system of claim 1, wherein the mannequin is configured for wearing of a respirator, safety goggles and/or eye protection simultaneous with the delivery system directing one or more testing materials into contact with a piece of personal protective equipment disposed over at least a portion of the outer surface of the mannequin.

15. The personal protective equipment testing system of claim 1, wherein an inner portion of mannequin is encased within the outer surface of the mannequin, and wherein the outer surface of the mannequin is resistant to corrosive chemical environments under elevated temperatures.

16. The personal protective equipment testing system of claim 1, wherein one or more of the plurality of sensors comprises a video camera.

17. The personal protective equipment testing system of claim 1, wherein the plurality of sensors comprise one or more of an ion-selective field effect transistor, an electrochemical sensor, a potentiometric sensor, a chemically modified electrode sensor, a metal oxide sensor, a photoionization detector, a thermocouple, a humidity sensor, an accelerometer, a mass spectrometer, an infrared spectrometer, an x-ray diffraction spectrometer, or a UV-Vis spectrometer.

18. The personal protective equipment testing system of claim 1, wherein the controller is configured to monitor, display, process and store data from the plurality of sensors.

19. The personal protective equipment testing system of claim 1, wherein one or more of the plurality of sensors is in wireless electronic communication with the controller.

20. A method of testing a piece of personal protective equipment, comprising:
i) disposing the piece of personal protective equipment over a mannequin of a personal protective equipment testing system;
ii) directing one or more testing materials into a testing enclosure such that at least a portion of the one or more testing materials contacts the piece of personal protective equipment; and
iii) obtaining an output from one or more of a plurality of sensors disposed within the testing enclosure;
wherein the personal protective equipment testing system comprises: a control enclosure in electrical communication with the testing enclosure, wherein the testing enclosure is configurable to prevent fluid communication with the control enclosure and to prevent fluid communication with an external environment;
the mannequin is disposed within the testing enclosure, wherein the mannequin has an outer surface having a shape approximating an adult human being, wherein the mannequin is configured to allow one or more pieces of personal protective equipment to be disposed over at least a portion of the outer surface;
the testing enclosure further comprising the plurality of sensors, each in electrical communication with a system controller, wherein at least one of the plurality of sensors is disposed on or located at or within the outer surface of the mannequin;
a delivery system in fluid communication with the testing enclosure in electronic communication with the system controller, the delivery system configured to direct one or more testing materials into the testing enclosure such that at least a portion of the one or more testing materials contacts a piece of personal protective equipment disposed over at least a portion of the outer surface of the mannequin;
wherein the system controller is configured to provide electronic communication between the control enclosure and the delivery system to manipulate an environment within the testing enclosure simultaneous with providing electronic communication between the control enclosure and the plurality of sensors.
